(19) United States
(12) Patent Application Publication
(10) Pub. No.: US 2001/0033432 A1
(43) Pub. Date: Oct. 25, 2001

(54) Glass lens for automotive lighting

(75) Inventor: Dennis B. Clark, Bradford, OH (US)

Correspondence Address: CORNING INCORPORATED, SP-TI-3-1, CORNING, NY, 14831

(73) Assignee: Corning Incorporated

(21) Appl. No.: 09/805,288

(22) Filed: Mar. 13, 2001

Related U.S. Application Data
(63) Continuation-in-part of application No. 09/322,469, filed on May 28, 1999, now abandoned.

(51) Int. Cl. G02B 3/08; G02B 3/00

(52) U.S. Cl. 359/742; 359/743; 359/642

(57) ABSTRACT

A glass lens for an automotive, high intensity, high temperature lighting device. More specifically, the glass lens combines a sealed-beam lamp lens design with a Fresnel lens shaped portion that is integrally formed on the inner surface of the lens. This combined glass lens configuration removes the current need and practice to provide a second lens or cover to protect an inner, light converting and focusing lens. A single-piece, exterior glass lens construction that comprises a focusing Fresnel lens portion with a smooth peripheral portion is useful to reduce costs and simplify manufacture of lamp components for automotive lighting devices, such as headlamps or fog lamps, to which the present invention is directed.

This application is a continuation-in-part of U.S. Pat. application No. 09/322,469, filed on May 28, 1999 in the name of Dennis B. Clark, and claims priority in part thereto.

### FIELD OF INVENTION

The present invention relates to a glass lens for use in automotive lighting. More particularly, the invention relates to a substantially flat, single-piece lens having a Fresnel-shaped elevation or lens portion that is integrally formed on the inner or back surface of the glass lens. The glass lens can be installed as an outer cover for use in sealed beam, high intensity, forward-end lighting, such as headlamps or fog lamps.

### BACKGROUND OF INVENTION

Automotive lamps, such as high-end headlamps or fog lamps, typically consist of several components, including a reflector, a light source—such as a light bulb—an inner lens for converting and focusing light beams from the light source, and an outer lens or cover to protect the inner lens from damage and to complete the lamp assembly. In less expensive sealed-beam lamps, a focusing or light converting lens is not used. The aforementioned separate components are assembled together by epoxy, glue or other means resulting in a costly and cumbersome production process, in addition to placing limitations on lens and lamp design. Simplification of the production process and cost savings could be achieved by reducing the number of components. For example, the outer and inner lenses could be combined into a one-piece unit. Moreover, the need for a one-piece lens unit that reduces lamp production costs can concurrently afford automobile manufacturers more flexibility in lamp designs.

The inner lens used in conventional headlamp devices is made of glass and may be an aspheric lens or have a Fresnel-shaped lens configuration. The former, aspheric lens design although heavier, however, is more preferred in the industry because of its relative manufacturing simplicity and good optical performance. A fresnel-shaped aspheric lens is described in U.S. Pat. No. 3,743,385 issued to Schaefer ('385), the contents of which are incorporated herein by reference. The Schaefer '385 design is a combination fresnel/aspheric component system that requires an outer lens cover.

Typically, a pressing operation is used to make a glass lens. Pressing processes known in the art, however, would not be compatible with producing a one-piece lens unit, including an aspheric lens, because the variation in glass thickness would be so great that quality and performance would be sacrificed.

Thus, a need exists for an improved automotive lighting device for use in forward-end, high intensity lights, such as headlamps or fog lamps. The improved lighting device would comprise a single-piece glass lens that can be made with glass pressing techniques but still possess the same optical properties of a lamp made with an aspheric lens.

### SUMMARY OF THE INVENTION

The invention relates to an automotive forward lighting device, such as used in either main-beam headlamps or fog lamps. The lighting device comprises a glass lens made of a single-piece of glass, having formed or molded on its inner surface, facing toward a light source, a Fresnel-shaped lens elevation. The lens has a relatively smooth peripheral section surrounding the Fresnel-shaped elevation. The Fresnel-shaped portion is circular and preferably centrally located within the parameters of the lens. The glass lens itself is substantially flat, and has a shape selected from the group consisting of parallelogram, square, rectangular, rhombic, circular, oval, triangular, and polygonal shapes. The lighting device further comprises a reflector and a light source, such as an incandescent or halogen light bulb, or high intensity discharge (HID) lamp, wherein the glass lens seals to a rim of an open end of the reflector.

The lighting device combines, in an embodiment, a standard sealed beam lens configuration with the Fresnel-shaped lens that is integrally formed to the inner surface of the glass. This configuration eliminates the need for a separate protective lens cover, thereby reducing costs and complexity in manufacture. Since, current automotive lamps typically consist of multi-component systems that could include a separate inner Fresnel lens within a lamp assembly. Such systems must protect the internal optical components with an outside lens cover that is usually made from a clear plastic or glass, which contributes to both costs and weight. Front-end main-beam headlamps or fog lamps require a great intensity of luminescence. To produce greater brilliance, manufacturers require a hotter and mere intense light source. Because of the high temperatures of most fog and driving lamps, glass must be used as the lensing material, since plastics can not withstand the high temperatures, thermal changes, or wear forces. In comparison, having been used for automotive rear lighting where the temperatures do not interfere with performance, plastics, however, if exposed to the temperatures of such front-end lights will likely soften, discolor, and deform. Examples of the kinds of glass that the present lens can be made from include borosilicates, aluminoborosilicates, aluminosilicates, and soda-line silicates. The outer surface of the inventive glass lens (with the Fresnel-shaped elevation formed integrally on its inner surface) can become the outermost surface of the lighting assembly without the need for an additional protective cover. The glass lens is strong enough to resist environmental conditions such as weather and road debris that may cause damage to a conventional focusing lens that does not have a protective cover. The invention also relates to the glass forming process. Additionally, a sealed beam lamp configuration does not have, nor require a light-focusing, aperture plate, which further simplifies lamp design and reduces costs.

### BRIEF DESCRIPTION OF THE DRAWINGS

FIG. 1 illustrates a top view of a substantially planar glass lens that has a Fresnel-shaped portion integrally formed on an inner surface with the lens, having a smooth, peripheral portion.

FIG. 2 illustrates a cross-sectional view taken generally along line A-A in FIG. 1.

FIG. 3 illustrates an expanded view of section B in FIG. 2.

FIG. 4 illustrates an expanded view of section C in FIG. 2.

FIG. 5 illustrates a cross-sectional view of an embodiment of an automotive lamp comprising a reflector, a light source, and a lens according to the present invention.

### DETAILED DESCRIPTION OF PREFERRED EMBODIMENT

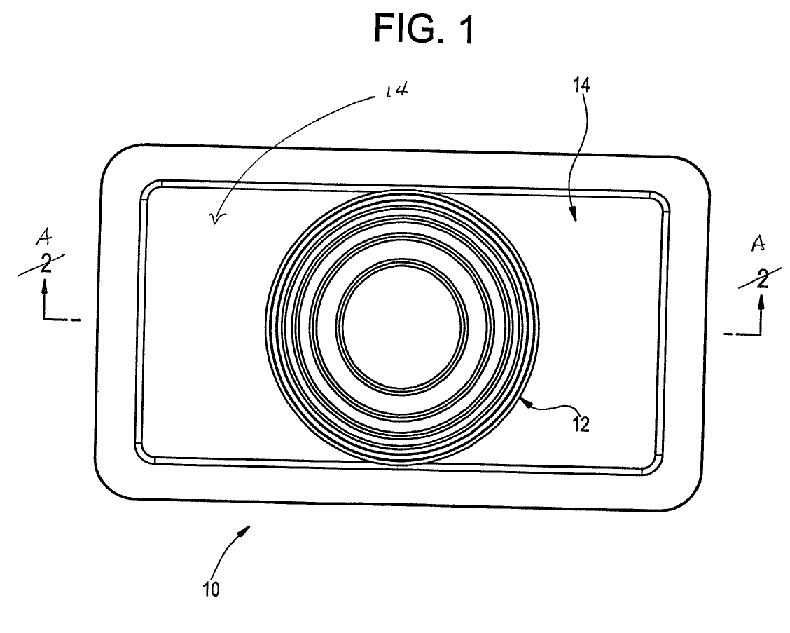

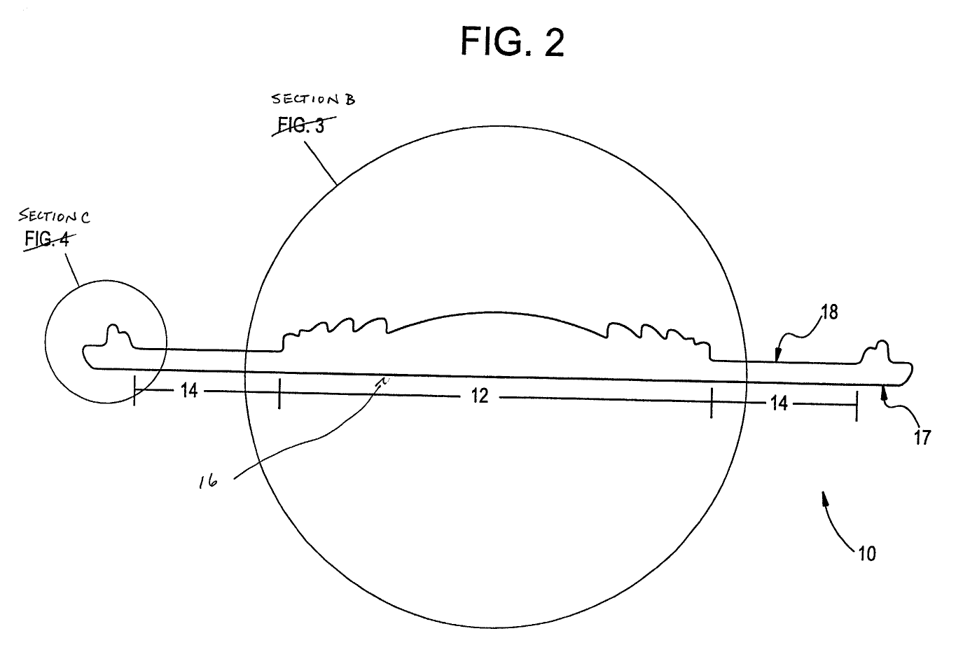

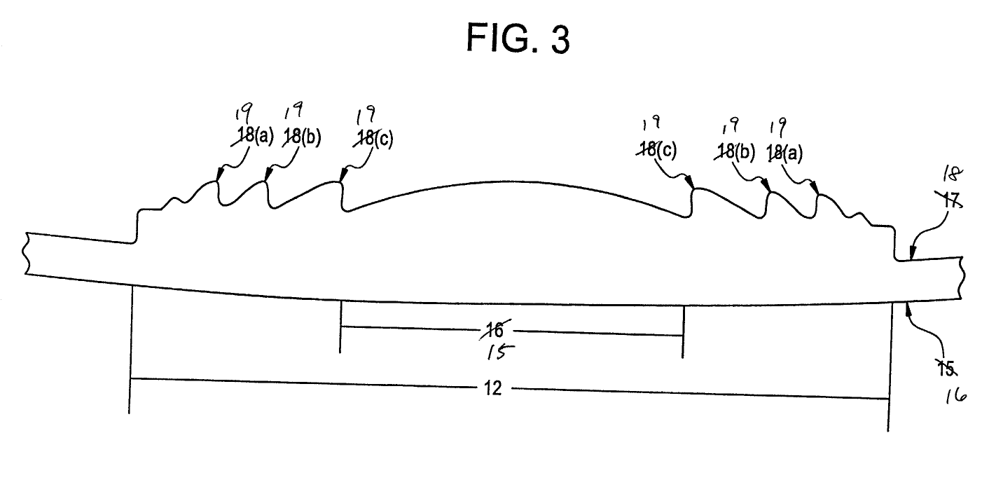

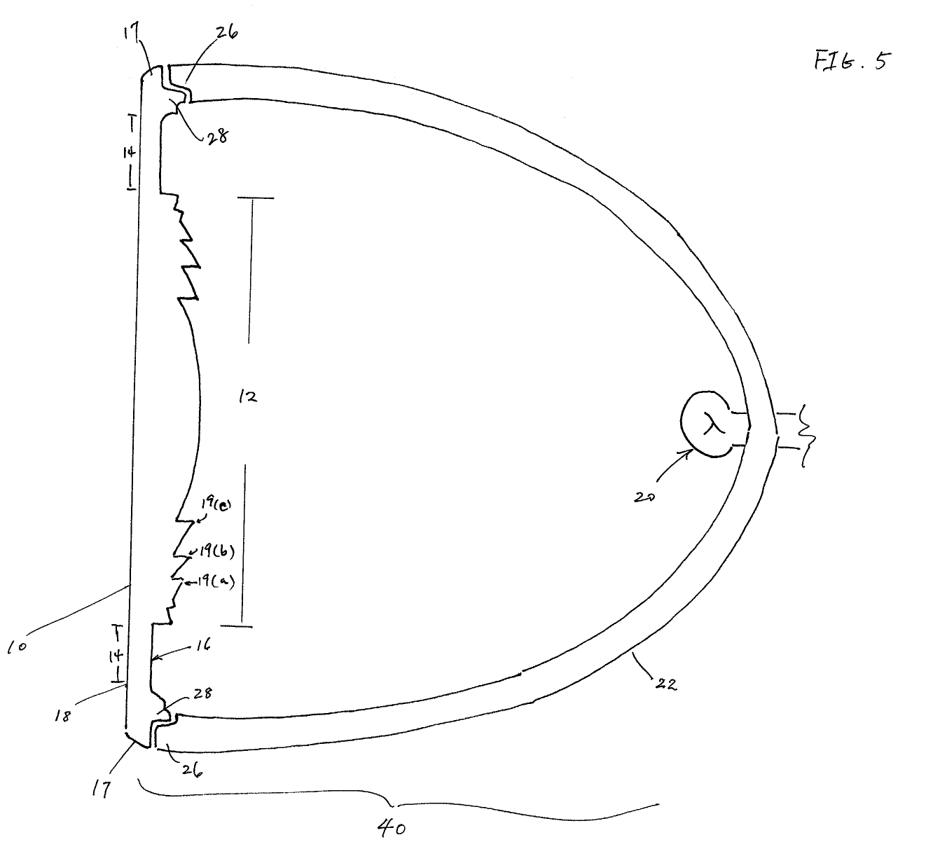

FIGS. 1 through 5 depict a preferred embodiment of the present invention. FIG. 1 is a top or face-on depiction of the inventive glass lens having, in this example, a rectangular configuration. FIG. 2 shows a cross-sectional view of a relatively flat, single-piece glass lens that comprises a Fresnel-shaped elevation or portion 12, and a planar, peripheral portion 14. Lens 10 has a first face 16 and a second face 18, and is preferably made of glass selected from borosilicate, aluminoborosilicate, and soda-lime silicate. The first face 16 is relatively flat and becomes the outside face when the lens is assembled into a lamp. The second face 18 or inner surface is also relatively flat, but contains a Fresnel-shaped lens portion 12 that is formed or molded as an integral part of the glass lens on the inner surface. Shown in detail in FIG. 3, the Fresnel-shaped elevation 12 is centrally located in the optical-light path of the lens, so as to focus and channel a concentrated beam of light out of the lamp. As seen in FIG. 5, a sealed-beam lamp 40 of a preferred embodiment comprises a light source 20 that is detachably mounted on a reflector 22. The reflector 22 is designed in the shape of a parabolic cup to better concentrate light emitted from the light source 20 to the Fresnel-shaped portion 12 of the glass lens 10, where it is focused and discharged out of the lamp. The reflector can be made from glass, metal or plastics with a reflective coating. An example of a suitable reflector is disclosed in U.S. Pat. No. 4,994,948, the content of which is herein incorporated by reference.

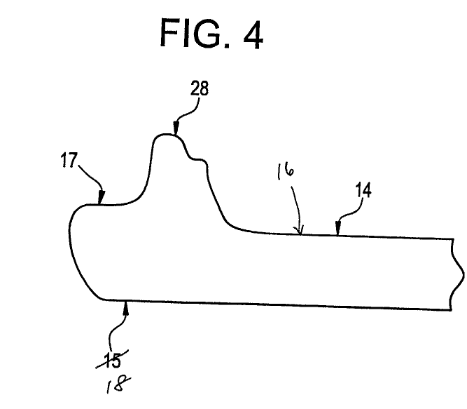

As shown in detail in FIGS. 2 and 4, the lens 10 has a number of projections 28 extending from the inner surface 16 near the terminal edge 17 at each end of the lens. These projections 28 engage the open end 26 of the reflector 22, to create a fitted seal. Attachment of the lens to the reflector may be achieved by any suitable sealing means known in the art, such as by applying epoxy or glass frits. The lens and reflector sealed together as a unit forms lamp 40. A second lens or cover material, which ordinarily would be used to protect the light converting lens —i.e., lens 10—is not needed in the present invention. The present invention combines the cover lens and converting lens in one glass. Hence, the inventive glass lens configuration may be used as an exterior component of a high intensity lighting device, such that the outer surface of the lens can resistant exposure to environmental conditions, such as the weather, road debris, and dirt without detriment. Elimination of the need for a protective cover or second lens reduces lamp manufacture costs, which in turn translates to savings to the end consumer, and enables automotive lamp designers more latitude and flexibility in design options. This last feature is desirable in the automotive industry where designs are constantly changing and evolving.

In an example of a preferred embodiment, lens 10 has dimensions of approximately 3.3 inches×5.8 inches. The Fresnel-shaped portion 12 includes a convex section 15 bounded by a series of elevations 19(a), 19(b), and 19(c) as shown in detail in FIG. 3. Elevations 19(a), 19(b), and 19(c) have heights of 0.079 inches, 0.090 inches, and 0.101 inches, respectively. The Fresnel-shaped portion 12, has a total diameter of approximately 2.6 inches, and is preferably located in front of and facing the light source 20, such that the light source 20 is behind the optical center of the lens. In other words, the Fresnel-shaped elevation is located at the optical center of the glass lens, such as to be in a direct optical path from said light source and provides maximum focus and transmission of light.

Sealed beam lenses are currently manufactured in both glass and plastic materials, and Fresnel lenses can be made of both plastic and glass. To combine these two types of lens into one material, however, is very difficult to do in glass. Even though plastic materials can be formed into many more kinds of shapes, has less weight, and can hold sharper definitions, glass is preferred for use in high intensity lighting devices such as either headlamps or fog lamps. Glass is much more resistant to high temperatures, while plastics would likely deform or melt under the high temperature conditions necessary to produce the requisite intensity of illumination. Plastic materials are thermal injection molded. Glass lenses are pressed.

Conventional hot-pressing techniques may be employed in the manufacture of the present inventive lens. Pressing involves a mold, plunger, and ring apparatus assembly. A Fresnel lens shape is constructed in the plunger portion of the molding equipment. This plunger also contains the inner shape of the finished lens cover. A charge or gob of molten glass is placed in the mold and the plunger-ring apparatus is introduced into the gob of glass, so as to press-form a finished lens between the mold, ring and plunger combination. The result is a one-piece configuration of a sealed beam lens with a Fresnel lens at its center of optical transmission. But, to achieve the desired conformation of the Fresnel-shaped elevation, a more preferred pressing method would need to be developed. The problem that needs to be addressed is the fact that glass flows. Glass molds can be produced to reflect sharp corners, but when glass is placed into the mold at a high temperature and then pressed to shape, the cooled final result does not yield exactly the same, desired shape. As a plunger in a mold is withdrawn, glass would still be able to flow as it cools. Thus, a natural radius forms at a locus where a sharp edge or comer is desired.

In a possible preferred method of pressing, the pressing temperature of the gob is increased to become less viscous. Borosilicate glass globs of temperatures in the range of about 1300-400° C., or at about 1000-3000 poise may work. In another approach that may be combined with the low viscosity, the process is slowed down and the glass is quickly quenched to prevent slumping, thus the glass is able to maintain the desired Fresnel shape. A slower pressing involves letting the mold plunger dwell for a longer period over a charge of glass than under current processing speeds. The plunger remains, or dwells, on the glass for a deliberate, predetermined duration. Plunger dwelling times can range from 1 to 15 seconds, preferably about 3-9 seconds, or even more preferably about 4-5-6 seconds, as compared to dwelling times of fractions of a second used in current processing. By holding the plunger in place for even such a short increase in duration, the charge of glass begins to set and is better able to maintain a relatively sharp Fresnel lens profile. Although, dwelling times should not be so long as to cause damage, such as checking, in the glass. Down air-cooling can be employed immediately as the plunger is lifted off or removed, to reinforce cooling and prevent the glass from slumping. In hand pressing experiments where plungers dwelled for 4-6 seconds on a charge of glass, we were able to produce Fresnel edges that had significantly improved sharpness over previous press molded attempts in glass. Thus, the invention also comprises a process for molding a sealed beam lens and relatively sharp Fresnel lens components in a single piece of glass.

Although the present invention has been fully disclosed by way of example in a preferred embodiment, it will be clear to one skilled in the art that various changes or modifications may be made to an embodiment of the invention without departing from the spirit and scope of the present invention as set forth in the following claims.

We claim:

1. A lighting device for use in high intensity lights comprising a glass lens, said lens being made of a single piece of glass having a Fresnel-shaped elevation integrally formed on an inner surface of said glass lens, wherein said glass lens is an exterior component of said lighting device, such that said glass lens does not require an outer protective cover.

2. The lighting device according to claim 1, wherein said device further comprises a reflector and a light source, wherein said glass lens seals to a rim of an open end of said reflector.

3. The lighting device according to claim 1, wherein said glass lens is in the form of a standard automotive sealed-beam lens.

4. The lighting device according to claim 1, wherein said glass is selected from the group consisting of borosilicate, aluminoborosilicate, aluminosilicate, and soda-lime silicate glasses.

5. The lighting device according to claim 1, wherein said Fresnel-shaped elevation faces said light source.

6. The lighting device according to claim 1, wherein said Fresnel-shaped elevation is located at the optical center of said glass lens, such as to be in a direct optical path from said light source and provides maximum focus and transmission of light.

7. The lighting device according to claim 1, wherein said Fresnel-shaped elevation is circular.

8. The lighting device according to claim 1, wherein said glass lens is substantially planar.

9. The lighting device according to claim 1, wherein said glass lens is has a shape that is selected from the group consisting of parallelogram, square, rectangular, rhombic, circular, oval, triangular, and polygonal shapes.

10. The lighting device according to claim 1, wherein said glass lens is rectangular in shape.

11. The lighting device according to 1, wherein said lighting device is an automotive, forward-end lamp.

12. An automotive lighting device for use in forward-end, high intensity lights comprising a glass lens, a reflector, and a light source, said lens being made of a single piece of glass having a Fresnel-shaped elevation integrally formed on an inner surface of said glass lens and having a form of a sealed-beam lens, wherein said glass lens seals to a rim of an open end of said reflector, and said glass lens is an exterior component of said lighting device, such that said glass lens does not require an outer protective cover.

13. The lighting device according to claim 12, wherein said glass is selected from the group consisting of borosilicate, aluminoborosilicate, aluminosilicate, and soda-lime silicate glasses.

14. The lighting device according to claim 12, wherein said Fresnel-shaped elevation faces said light source.

15. The lighting device according to claim 12, wherein said Fresnel-shaped elevation is located at the optical center of said glass lens, such as to be in a direct optical path from said light source and provides maximum focus and transmission of light.

16. The lighting device according to claim 12, wherein said Fresnel-shaped elevation is circular.

17. The lighting device according to claim 12, wherein said glass lens is substantially planar.

18. The lighting device according to claim 12, wherein said glass lens is has a shape that is selected from the group consisting of parallelogram, square, rectangular, rhombic, circular, oval, triangular, and polygonal shapes.

19. The lighting device according to claim 12, wherein said glass lens is rectangular in shape.

20. A method of making a glass lens for sealing to a rim of an open end of a high intensity light reflector, said method comprises: providing a plunger and mold apparatus assembly, said plunger having a pressing surface with a Fresnel lens shape configuration along with an inner shape of a finished sealed-beam glass lens in said pressing surface; providing a highly fluid gob of molten glass into said mold apparatus; introducing said plunger and ring into said gob of glass, so as to press-form a finished lens between said mold and plunger/ring; dwelling said plunger/ring for a predetermined duration; and quickly quenching said glass immediately as said plunger/ring is being removed, wherein said finished lens is in the form of an automotive sealed-beam lens and has a Fresnel-shaped elevation formed integrally on an inner surface.

21. The method according to claim 20, wherein said dwelling time is approximately 1-15 seconds.

22. The method according to claim 20, wherein said dwelling time is about 3-9 seconds.

23. The method according to claim 20, wherein said dwelling time is about 4-6 seconds.

24. The method according to claim 20, wherein said quenching is achieved by down air-cooling.

25. The method according to claim 20, wherein said gob of glass has a viscosity of about 1000-3000 poise.

26. An automotive lighting device for use in high intensity lights comprising a glass lens, said lens being made of a single piece of glass pressed according to a method, said method comprises: providing a plunger, ring, and mold apparatus assembly, said plunger having a pressing surface with a Fresnel lens shape configuration along with an inner shape of a sealed-beam glass lens in said pressing surface; providing a highly fluid gob of molten glass into said mold apparatus; introducing said plunger and ring into said gob of glass, so as to press-form a finished lens between said mold and plunger/ring; dwelling said plunger/ring for approximately 1-15 seconds; and quickly quenching said glass immediately as said plunger/ring is removed, wherein said finished lens is in the form of a sealed-beam lens and has a Fresnel-shaped elevation integrally formed on an inner surface of said glass lens and is an exterior component of said lighting device, such that said glass lens does not require an outer, protective cover.

27. The lighting device according to claim 26, wherein said dwelling time is about 3-9 seconds.

28. The lighting device according to claim 26, wherein said dwelling time is about 4-6 seconds.

29. The lighting device according to claim 26, wherein said quenching is achieved by down air-cooling.

30. The lighting device according to claim 26, wherein said device further comprises a reflector and a light source, wherein said glass lens seals to a rim of an open end of said reflector.

31. The lighting device according to claim 26, wherein said charge of glass is selected from the group consisting of borosilicate, aluminoborosilicate, aluminosilicate, and soda-line silicate glasses.

32. The lighting device according to claim 26, wherein said Fresnel lens shaped configuration is located at the optical center of a sealed-beam glass lens, with a smooth surface portion peripherally located to said Fresnel lens shaped configuration.

33. The lighting device according to claim 26, wherein said Fresnel lens shaped configuration is circular.

34. The lighting device according to claim 26, wherein said mold having a bottom surface that produces a substantially planar finished glass lens.

35. The lighting device according to claim 26, wherein said mold produces a glass lens that has a shape that is selected from the group consisting of parallelogram, square, rectangular, rhombic, circular, oval, triangular, and polygonal shapes.

36. The lighting device according to claim 26, wherein said gob of glass has a viscosity of about 1000-3000 poise.
